(19) United States
(12) Patent Application Publication
(10) Pub. No.: US 2022/0082703 A1
(43) Pub. Date: Mar. 17, 2022

(54) METHOD FOR DETERMINING A VISIBILITY

(71) Applicant: Conti Temic microelectronic GmbH, Nürnberg (DE)

(72) Inventor: Günter Anton Fendt, Schrobenhausen (DE)

(73) Assignee: Conti Temic microelectronic GmbH, Nürnberg (DE)

(21) Appl. No.: 17/309,651

(22) PCT Filed: Nov. 12, 2019
(86) PCT No.: PCT/DE2019/200132

§ 371 Date: Jun. 11, 2021

(30) Foreign Application Priority Data
Dec. 11, 2018 (DE) 10 2018 221 448.4

(51) Int. Cl. G01S 17/95; G01N 21/47

(52) U.S. Cl. CPC G01S 17/95; G01S 17/931; G01N 21/47

(57) ABSTRACT

Disclosed is a method for determining a visibility using a sensor unit, in particular a lidar sensor, including having the sensor unit emit a transmission signal, capturing a received signal backscattered by an object, determining the distance from the object using the received signal, and determining the visibility on the basis of the ascertained distance from the object and/or the strength of the received signal.

### CROSS-REFERENCE TO RELATED APPLICATIONS

This application is a national stage application, filed under 35 U.S.C. § 371, of International Patent Application No. PCT/DE2019/200132, filed on Nov. 12, 2019, which is incorporated by reference herein.

### TECHNICAL FIELD

The technical field relates generally to a method for determining a visibility using a sensor unit, and more specifically to a sensor unit comprising a lidar sensor, a method for emitting a speed recommendation to a vehicle operator, which involves determining the visibility as well as a sensor unit for carrying out a method.

### BACKGROUND

Generic sensor units which are deployed, e.g., in assistance systems, which capture the environment (e.g., with a camera sensor) and ascertain the clearance (e.g., by means of a radar or lidar sensor) are, as a general rule, part of the standard equipment of modern vehicles. Although such assistance systems are deployed and are increasingly being improved, it is not possible to avoid accidents completely since many accidents are nevertheless caused by human error or are the result of the vehicle operator misjudging a traffic situation. A common cause of accidents is poor or restricted visibility, in particular since such circumstances are often underestimated or misjudged by many vehicle operators and, as a result, they drive the vehicle at a speed which is not appropriate to the present visibility.

In the case of roads which have electronic traffic management, visibility range measuring systems are, for example, deployed for this purpose—e.g., roadside optical systems consisting of a transmitter and receiver which are arranged spaced apart from each other in order to be able to ascertain the prevailing visibility. Furthermore, taking into account the ascertained visibility, a speed recommendation or speed limit is emitted via a speed indication in order to consequently counteract the potential risks. Since not all roads are equipped with such speed indications, such accident-avoiding, regulating interventions can only be deployed on specific sections of the road, e.g., on freeways and highways.

In the case of roads which do not have electronic traffic management, the vehicle operator has to judge or evaluate the visibility himself and, as a result of his judgement, adjust the vehicle speed according to the traffic situation.

A light-dependent sensor device for determining visibility outside a motor vehicle is known from DE 40 17 051 A1. The sensor device identifies the prevailing visibility in front of or behind the vehicle and, accordingly, triggers a speed recommendation or other precautionary or warning measure.

Furthermore, DE 39 30 272 A1 describes a lidar sensor which can be used for determining visibility so that the driving speed is, as a result, controlled depending on the existing visibility. However, the lidar sensor has a very complex construction with different receiving apparatuses/mirror arrangements which are used to determine the visibility.

As such, there remains an opportunity to simply the process of determining the visibility and improve the operational safety in an inexpensive way.

### SUMMARY

In a method for determining the visibility using a sensor unit, in particular a lidar sensor for measuring the clearance (clearance sensor), a transmission signal of the transmitting unit is first emitted. This transmission signal hits an object and is backscattered by said object and captured by a receiver unit as a received signal. The distance from the object is subsequently determined using the received signal, e.g., via the transit time of the signal. Furthermore, the current visibility is determined based on the ascertained distance from the object and/or the strength of the received signal. This results in the advantage that it is possible to ascertain a visibility determination of the clearance-measuring system or of the sensor unit during operation. As a result, even abruptly changing visibility conditions can be identified or captured by the sensor unit. With the method, the weaknesses of a generic sensor unit or of a lidar sensor are very deliberately exploited, in order to obtain a usable (technology-based) evaluation of the visibility in the event of adverse (restricted) visibility. The light signals or laser beams are strongly attenuated, e.g., in the case of fog and high humidity/spray, as a result of which the measuring range of a lidar system is reduced accordingly. This effect occurs most notably because the light rays are, e.g., reflected, mirrored or deflected in a diffuse manner by finely distributed water particles in the air. The reflecting received signal strength of the electromagnetic waves resulting in the receiver is weakened accordingly, e.g., with respect to the received signal strength without any adverse effect when the visibility is unrestricted. As a result of the method according to the invention, the ascertained measurement results can be monitored using a statistical evaluation in order to ascertain a (technology-based) evaluation of the visibility. As a result, the determination of the visibility is simplified to a particular extent and the operational safety is considerably improved. In addition, the method can be implemented inexpensively in new systems and retrofitted in existing systems.

The distance of a first detection at which the object was detected for the first time can be expediently used in order to determine the visibility. As a result, the current visibility can be established in a simple manner by defining the first detection as a constant to which the measured distance refers, i.e., a parameter or a characteristic is used, the value of which changes (e.g., increases or decreases) as a general rule as the visibility changes.

An initial value may be specified for the distance of the first detection. In a practical way, the initial value for the distance is ascertained by the manufacturer or during the initial commissioning, i.e., at a time at which the visibility is not restricted. Furthermore, manufacturing-related (minimal) deviations of the sensors can be offset by this. On the other hand, initial values can also be predefined by the manufacturer for specific sensors. The respective initial value can then be provided for the sensor unit or the clearance-measuring system, e.g., on a memory.

According to one configuration, the visibility is determined using a comparison between the initial value which has been specified for the distance of the first detection and the distance of the first detection currently existing or ascertained by the clearance sensor. A value for the deviation can then be calculated from the comparison. Depending on the deviation, the current visibility can then be established. To this end, tolerances and/or thresholds can be specified in the system which, if they are exceeded or fallen short of, indicate a determined visibility.

Furthermore, an initial value of the strength which the received signal has at a definable distance from the object can also be specified in order to determine the visibility. In the event that visibility is restricted, a displacement of the distance can be established in that the specified received signal strength only exists at a shorter distance.

The visibility may be determined using a comparison between the initial value of the received signal strength and the received signal strength currently existing or measured at the definable distance from the object.

The size of the deviation from the respective initial value can be expediently determined using the comparison, wherein the visibility is graduated by a correlation of said gradations with the size of the deviation.

Multiple measuring points of the distance or of the received signal strength can also be simply averaged. This average can subsequently be enlisted in order to determine the visibility. This makes the determination even more secure in that measuring errors or erroneous individual measured values can be relativized by simple averaging, so that determination errors due to measuring errors can be avoided or at least reduced. This particularly increases operational safety.

In the same way, the visibility can then be determined using a comparison between the average and the respective initial value.

According to a particular configuration, the visibility can also be determined on the basis of the ascertained distance from the object and on the basis of the strength of the received signal. This allows a plausibility check to be implemented in order to validate the visibility conditions determined at any one time against each other by means of a comparison with other determinations. This increases operational safety even further.

In an alternative embodiment, a method for emitting a speed recommendation to an operator of a vehicle is described. First of all, the visibility is assigned to visibility classes using at least one parameter. This assignment can in particular be effected by the factory, during operation or also via updates which are made available to the vehicle by an overriding unit. A recommended speed (i.e., a speed recommendation) is then assigned to the visibility classes. The visibility for the vehicle operator is in particular determined during travel. Said determination can in particular be effected using the method described herein or using another method known from the prior art. The speed recommendation is then emitted by assigning the determined visibility in each case to a visibility class and the recommended speed of the respective visibility class is emitted. As a result, a speed recommendation for the prevailing visibility at any one time can be emitted to the driver simply and inexpensively, without the driver having to determine this himself.

The restriction of the vehicle operator by the visibility can be expediently provided as a parameter. The restriction of the vehicle operator by the visibility can be provided as quantified visibility classes and/or quantified visibility restrictions. For example, the visibility can be classified as “significant restriction”, “medium restriction” and “slight restriction”. This classification can be effected, for example, in that a high received signal strength is indicative of a slight restriction and a low received signal strength is indicative of a significant restriction. Furthermore, depending on the received signal strength and/or typical distance from the detected object, it is also possible to distinguish between, and classify, rain, snow, spray, wet conditions, fog and the like.

A correlation of the determined visibility with characteristics of the roadway may be provided. It is possible, e.g., to infer characteristics of the roadway such as, e.g., wet or icy conditions if “snow” or “rain” visibility has been determined. Furthermore, these road characteristics can be enlisted in order to emit a warning and/or a speed recommendation to the vehicle operator or to carry out an intervention in the vehicle guidance (speed adjustment, braking and/or steering maneuver or the like).

An acoustic or optical warning or a signal can be expediently emitted to the user or the vehicle operator in the event of restricted visibility or determined or selected visibility, so that the latter is informed in good time of any difficulties which may occur in the vehicle guidance. For example, this can increase the road safety and operational safety of the vehicle even further, since the vehicle operator is immediately informed of any changes in conditions in the vehicle guidance in order to allow him to react accordingly.

Furthermore, the present disclosure includes a sensor unit which has a transmitting and a receiving unit for determining the clearance, in particular a lidar sensor, which may be used for measuring the clearance (clearance measuring system), wherein the sensor unit is designed to carry out the method described herein.

### BRIEF DESCRIPTION OF THE DRAWINGS

The disclosure will be explained in greater detail below with reference to expedient exemplary embodiments, wherein:

FIG. 1 shows a simplified schematic diagram of a typical driving scenario;

FIG. 2 shows a simplified schematic diagram of an evaluation possibility of the method according to one embodiment, and

FIG. 3 shows a simplified diagram of the relationship between the determination of the visibility and speed recommendation.

### DETAILED DESCRIPTION

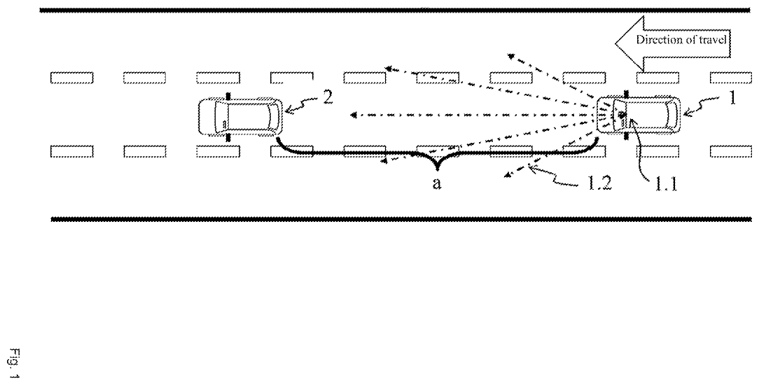

A typical scenario with two vehicles 1, 2, in which the first vehicle 1 is following the second vehicle 2 or approaching an object (in this case vehicle 2), is depicted in FIG. 1. Instead of the second vehicle 2, another, possibly stationary object could, however, also be provided such as, e.g., a traffic pole or a guardrail. In vehicle 1 there is a clearance-measuring system having a sensor unit 1.1, by means of which, e.g., the clearance a from the vehicle 2 can be ascertained. The measurement is effected in that the sensor unit 1.1 emits a transmission signal 1.2 by means of a transmitting unit, which transmission signal is reflected by the vehicle 2 (not depicted in FIG. 1 for the sake of clarity). The reflected signal is subsequently received as a received signal by a receiver unit of the sensor unit 1.1. A second receiver unit is not required. As a general rule, a sensor unit 1.1 has a measurement threshold, within which an object or an obstacle can be captured. As a consequence, it is only possible to capture the object with a defined clearance or within a defined distance from the object. In particular, the sensor unit 1.1 can comprise a lidar (light detecting and ranging) sensor. For example, the transmitting unit can, e.g., comprise a laser diode, by means of which a light or laser signal can be transmitted. Alternatively or additionally, other sensors known from the prior art (radar, camera) can, however, also be provided.

The current visibility, i.e., a weakening of the transmitting unit and/or a reduction of the reception sensitivity of the receiver unit of the sensor unit 1.1, can be determined by virtue of reflections and diffusions by particles and flecks, using the first capturing of the object, i.e., of the first detection. The visibility can consequently be securely captured or identified with the aid of two variants V1, V2.

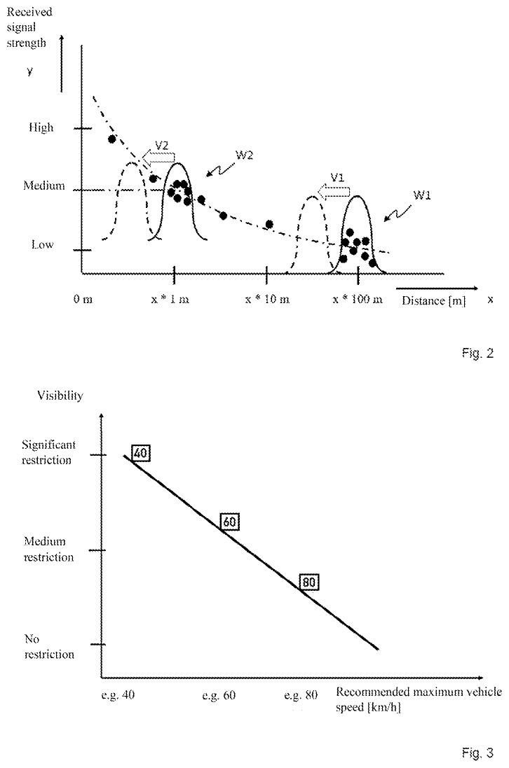

The results of multiple (clearance) measurements which have been generated, e.g., by the sensor unit 1.1 are depicted in FIG. 2, wherein each measuring point of the sensor (or the received signal strength) is assigned to a typical distance by means of a distribution curve. Furthermore, the two variants V1 and V2 for determining the visibility are depicted in a considerably simplified manner using the white arrows.

In the case of the first variant V1, a statistical evaluation is effected in such a way that the distance a is ascertained, at which distance an object is identified for the “first time” (correspondingly with a low received signal strength) when the vehicle is moving towards the object, the so-called first detection. In the event of adverse visibility or in the event of the visibility deteriorating, this distance (or the distribution curve) of the first detection is displaced towards a shorter distance, i.e., the obstacle is detected later in time and with a smaller clearance from the object. This effect occurs as a result of the beams of the lidar system being significantly attenuated in poor visibility conditions such as, e.g., fog, high humidity or spray, as a result of which the range of the system is reduced, so that the clearance at which the object can be detected by the measuring system decreases. Conversely, this means that in the event of the distribution curve being displaced, according to FIG. 2, in the direction of a shorter distance, i.e., along the x-axis in the direction of the y-axis as depicted by the arrow marked with V1, worse visibility conditions exist or the visibility has deteriorated, e.g., as a result of water particles finely distributed in the air, e.g., in the event of fog, wet conditions or spray.

In order to carry out the method, an initial value W1 for the distance of the first detection can, for example, be specified. The initial value W1 for the distance of the first detection is preferably specified by the manufacturer or during the initial commissioning, i.e., at a time at which, e.g., the prevailing visibility conditions are good. This initial value W1 can then in each case be compared with the value of the distance of the first detection, which is currently ascertained by the clearance sensor. From this comparison, a value for the deviation can then be calculated. Depending on this deviation, the currently existing visibility is then inferred, for example by storing tolerances and/or thresholds in the system which, if they are exceeded, indicate a deterioration of the visibility. Furthermore, the size of the deviation from the respective initial value W1 is determined using the comparison, wherein the visibility is graduated by correlating the gradations with the size of the deviation. For example, the visibility can be classified in visibility classes, e.g., “good” or “bad” or according to the restriction of the visibility (significant, medium or slight restriction) or into specific weather events (snow, rain, fog, spray and the like).

Alternatively or in addition to the first variant V1, the visibility can also be determined according to the second variant V2. In the case of variant V2, a statistical evaluation is effected in such a manner that a typical distance with a corresponding distribution can be deduced using a defined received signal strength.

In the same way, an initial value W2 of the strength which the received signal has at a definable distance from the object can also be specified, in order to determine the visibility. The visibility prevailing at any one time is likewise determined using a comparison between the initial value W2 of the received signal strength and the received signal strength currently existing or measured at the definable distance from the object. The visibility classes can then be classified or specified in a correlating manner with the received signal strength (e.g., high received signal strength stands for good visibility or a small restriction of the visibility).

Due to worsening visibility, the distance (the distribution curve) is displaced at the defined received signal strength towards a shorter distance. This effect occurs as a result of the fact that the optical signals are attenuated in poorer visibility conditions so that a lower received signal strength exists and the obstacle has to be brought closer to the measurement system in order to obtain the initially defined received signal strength again. Conversely, this means that if the distribution curve is displaced towards a shorter distance, i.e., as depicted by the arrow marked with V2, along the x-axis in the direction of the y-axis, it is possible to infer poorer visibility conditions. A displacement is identified by the measurement results moving away over time from the original (stored) measured values or initial values W1, W2. The displacement is a function of adverse visibility conditions, or a (technology-based) inference of the adverse effect on the view can be drawn using the size of the displacement. Other vehicles, or roadside boundary posts, road signs, trees and the like can be enlisted as obstacles or objects to be evaluated (the respective “obstacle class” has a typical distance at which the obstacle can be captured for the first time by a system for capturing the surroundings if the view is unrestricted, and can consequently be enlisted as a reference). The method can consequently be applied with all clearance-measuring systems and is expressly not restricted to just lidar sensors.

In order to improve the determination reliability, it is also possible to average multiple measuring points of the distance or of the receiver signal strength, as depicted in a very simplified manner in FIG. 2. Said average can subsequently be enlisted in order to determine the visibility. The visibility can then be determined using a comparison between the average and the respective initial value W1 or W2. Furthermore, a plausibility check can also be provided, e.g., by checking or validating the visibility which has been ascertained by the first variant against the result of the visibility determination by utilizing the second variant. In the same way, the visibility which has been ascertained by the second variant can also be checked or validated against the first variant.

Multiple measuring points of the distance or of the received signal strength can consequently also be simply averaged during the evaluation in order to make the determination even more secure. Thanks to such an averaging, measuring errors or erroneous individual measured values can be relativized, so that this cannot lead to misinterpretations by compensating for the deviating measured values by averaging with other measurement results.

The functional dependence between the current visibility and a speed recommendation or speed regulation is depicted by way of example in FIG. 3. A maximum vehicle speed is generated and displayed as a recommendation by an independently functioning assistance system depending on the current visibility (ascertained, e.g., with a lidar-based clearance measuring system). The display can be effected optically or acoustically. The visibility can either be determined using the method according to the invention or in another way such as, e.g., using transmitted information (car-to-car, car-to-X transmissions).

In summary, the vehicle operator can be provided with an independently functioning assistance function according to the invention (determination of visibility via lidar and resulting, recommended speed limitation). In particular, road safety can be particularly improved on routes which do not have digitization or a speed indication for adapting the speed in the event of adverse visibility conditions, so that the disclosure represents a very special contribution to the field of driver assistance functions.

### LIST OF REFERENCE NUMERALS

1 First vehicle
1.1 Sensor unit
1.2 Transmission signal
2 Second vehicle
a Distance
V1 First variant
V2 Second variant
W1 Initial value
W2 Initial value

1-15. (canceled)

16. A method for determining a visibility using a lidar sensor, said method comprising:
having the lidar sensor emit a transmission signal;
capturing a received signal backscattered by an object;
determining the distance from the object using the received signal; and
determining the visibility based on at least one of the ascertained distance from the object and the strength of the received signal.

17. The method according to claim 16, wherein the distance of a first detection at which the object was detected for the first time is used in order to determine the visibility.

18. The method according to claim 17, wherein an initial value is specified for the distance of the first detection.

19. The method according to claim 18, wherein the visibility is determined using a comparison between the initial value and the currently existing distance of the first detection.

20. The method according to claim 19, wherein an initial value of the strength which the received signal has at a definable distance from the object is specified.

21. The method according to claim 20, wherein the visibility is determined using a comparison between the initial value and the received signal strength currently existing at the definable distance from the object.

22. The method according to claim 21, wherein the size of the deviation from the initial value is determined using the comparison and the visibility is classified by a correlation with the size of the deviation.

23. The method according to claim 22, wherein multiple measuring points of at least one of the distance and of the received signal strength are averaged, and the average is used in order to determine the visibility.

24. The method according to claim 23, wherein the visibility is determined using a comparison between the average and the respective initial value.

25. The method according to claim 16, wherein the visibility is determined on the basis of the ascertained distance from the object and on the basis of the strength of the received signal, wherein a plausibility check is provided in order to validate the visibility conditions ascertained during this against one another.

26. The method as set forth in claim 16, further comprising:
assigning the determined visibility to one of a plurality of visibility classes using at least one parameter;
assigning a recommended speed to each of the visibility classes;
emitting the recommended speed of the respective visibility class to a vehicle operator.

27. The method according to claim 26, wherein the restriction of the vehicle operator by the visibility is provided as a parameter, wherein the restriction is in particular specified as quantified visibility classes and/or quantified visibility restrictions.

28. The method according to claim 16, further comprising correlating the determined visibility with characteristics of the roadway wherein the characteristics of the roadway are enlisted in order to emit a warning or a speed recommendation or to carry out an intervention.

29. The method according to claim 16, further comprising providing at least one of an optical warning and ab acoustic warning in order to notify the determined visibility.
